(19) United States
(12) Patent Application Publication
(10) Pub. No.: US 2012/0032941 A1
(43) Pub. Date: Feb. 9, 2012

(54) Liquid crystal display device with low power consumption and method for driving the same

(76) Inventors: Yung-Chih Chen, Hsin-Chu (TW); Kuo-Chang Su, Hsin-Chu (TW); Chih-Ying Lin, Hsin-Chu (TW); Yu-Chung Yang, Hsin-Chu (TW)

(21) Appl. No.: 13/190,446

(22) Filed: Jul. 25, 2011

(30) Foreign Application Priority Data
Aug. 6, 2010 (TW) 099126278

(51) Int. Cl. G09G 3/36; G09G 5/00

(52) U.S. Cl. 345/212; 345/99

(57) ABSTRACT

A liquid crystal display device includes a timing controller and a charge-sharing circuit. The timing controller is configured to provide a plurality of input clock signals having duty cycle smaller than ⅓. The charge-sharing circuit is configured to allow charge-sharing to occur between a specific input clock signal and two other input clock signals respectively during the signal rising period and signal falling period of the specific input clock signal, thereby providing a plurality of output clock signals for driving a shift register.

### BACKGROUND OF THE INVENTION

1. Field of the Invention

The present invention is related to a liquid crystal display device and related driving method, and more particularly, to a liquid crystal display device with low power consumption by charge sharing and related driving method.

2. Description of the Prior Art

Liquid crystal display (LCD) devices, characterized in low radiation, thin appearance and low power consumption, have gradually replaced traditional cathode ray tube display (CRT) devices and are widely used in electronic products such as notebook computers, personal digital assistants (PDAs), flat-panel TVs, or mobile phones. In a traditional LCD device, images are displayed by scanning the pixels of the panel using external source drivers and gate drivers. However, gate driver-on-array (GOA) technique has been developed in order to reduce the number of devices and manufacturing costs by fabricating driving circuits directly on the substrate of the panel.

FIG. 1 is a diagram of a prior art LCD device 100 with GOA structure. The LCD device 100 includes a display panel 110, a timing controller 120, a source driver 130, and a gate driver 140. A plurality of data lines DL₁-DLₘ, a plurality of gate lines GL₁-GLₙ, and a pixel array are disposed on the display panel 110. The pixel array includes a plurality of pixel units PX each having a thin film transistor switch TFT, a liquid crystal capacitor C_{LC} and a storage capacitor C_{ST} and coupled to a corresponding data line, a corresponding gate line, and a common voltage V_{COM}. The timing controller 120 is configured to generate signals for operating the source driver 130 and the gate driver 140, such as a start pulse signal VST and input clock signals CK1 and CK2, etc. The source driver 130 is configured to generate data driving signals SD₁-SDₘ, corresponding to display images, thereby charging corresponding pixel units PX. The gate driver 140 is a two-phase shift register which includes a plurality of shift register units SR₁-SRₙ coupled in series. The gate driver 140 is configured to sequentially output the gate driving signals SG₁-SGₙ to the corresponding gate lines GL₁-GLₙ according to the input clock signals CK1, CK2 and the start pulse signal VST, thereby turning on the thin film transistors TFT in the corresponding pixel units PX.

FIG. 2 is a diagram illustrating a prior art driving method of the LCD device 100. In FIG. 2, the waveforms of the input clock signals CK1 and CK2, the start pulse signal VST, and the gate driving signals SG₁-SGₙ are depicted. In GOA structure, the input clock signals CK1 and CK2 with large voltage differential are directly applied to the glass substrate, and the parasitic capacitance of the panel is larger than that of a conventional driving chip. Therefore, although GOA technique may reduce manufacturing costs, it increases the overall power consumption of the LCD device 100. Other devices on the control circuit board may be burned out more easily due to increased power consumption, resulting in a shortened life time of the product.

### SUMMARY OF THE INVENTION

It is one of the objectives of the claimed invention to provide an LCD device with low power consumption and a related method to solve the abovementioned problems.

According to one embodiment, a method of driving an LCD device is provided. The method includes providing a first to an N^{th} input clock signals each having a duty cycle of 1/N, wherein N is an integer larger than 2; for a specific input clock signal among the first to the N^{th} input clock signals, allowing charge-sharing to occur between the specific input clock signal and two other input clock signals among the first to the N^{th} input clock signals during a signal rising period and a signal falling period of the specific input clock signal, respectively, thereby providing a first to an N^{th} output clock signals accordingly; and generating a plurality of gate driving signals according to the first to the N^{th} output clock signals.

According to one embodiment, an LCD device with low power consumption is provided. The LCD device includes a timing controller configured to provide a first to an N^{th} input clock signals each having a duty cycle of 1/N, wherein N is an integer larger than 2; a charge-sharing circuit configured to allow charge-sharing to occur between a specific input clock signal and two other input clock signals among the first to the N^{th} input clock signals during a signal rising period and a signal falling period of the specific input clock signal, respectively, thereby providing a first to an N^{th} output clock signals accordingly; and an N-phase shift register configured to generate a plurality of gate driving signals according to the corresponding first to the N^{th} output clock signals.

According to one embodiment, an LCD device with low power consumption is provided. The LCD device includes a timing controller configured to provide a first to a third input clock signals and a first to a fourth control signals, wherein a duty cycle of each input clock signal does not exceed ⅓; a shift register having a first to a third input ends; and a charge-sharing circuit. The charge-sharing circuit includes a first switch coupled between the first and second ends of the shift register and configured to selectively allow charge-sharing to occur between the first input clock signal and the second clock signal according to the first control signal; a second switch coupled between the second and third ends of the shift register and configured to selectively allow charge-sharing to occur between the second input clock signal and the third clock signal according to the second control signal; a first charge-sharing switch coupled between the timing controller and the shift register and configured to selectively transmit the first input clock signal from the timing controller to the first input end according to the fourth control signal; a second charge-sharing switch coupled between the timing controller and the shift register and configured to selectively transmit the second input clock signal from the timing controller to the second input end according to the fourth control signal; and a third charge-sharing switch coupled between the timing controller and the shift register and configured to selectively transmit the third input clock signal from the timing controller to the third input end according to the fourth control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art LCD device with GOA structure.

FIG. 2 is a diagram illustrating a prior art driving method of the LCD device.

FIG. 3 and FIG. 4 are diagrams of an LCD device with GOA structure according to embodiments of the present invention.

FIG. 5 is a diagram illustrating a charge-sharing circuit adopted prior to all control signals according to an embodiment of the present invention.

FIG. 6 and FIG. 7 are diagrams illustrating a driving method of the LCD device according to embodiments of the present invention.

FIG. 8A and FIG. 8B are diagrams illustrating a charge-sharing circuit according to embodiments of the present invention.

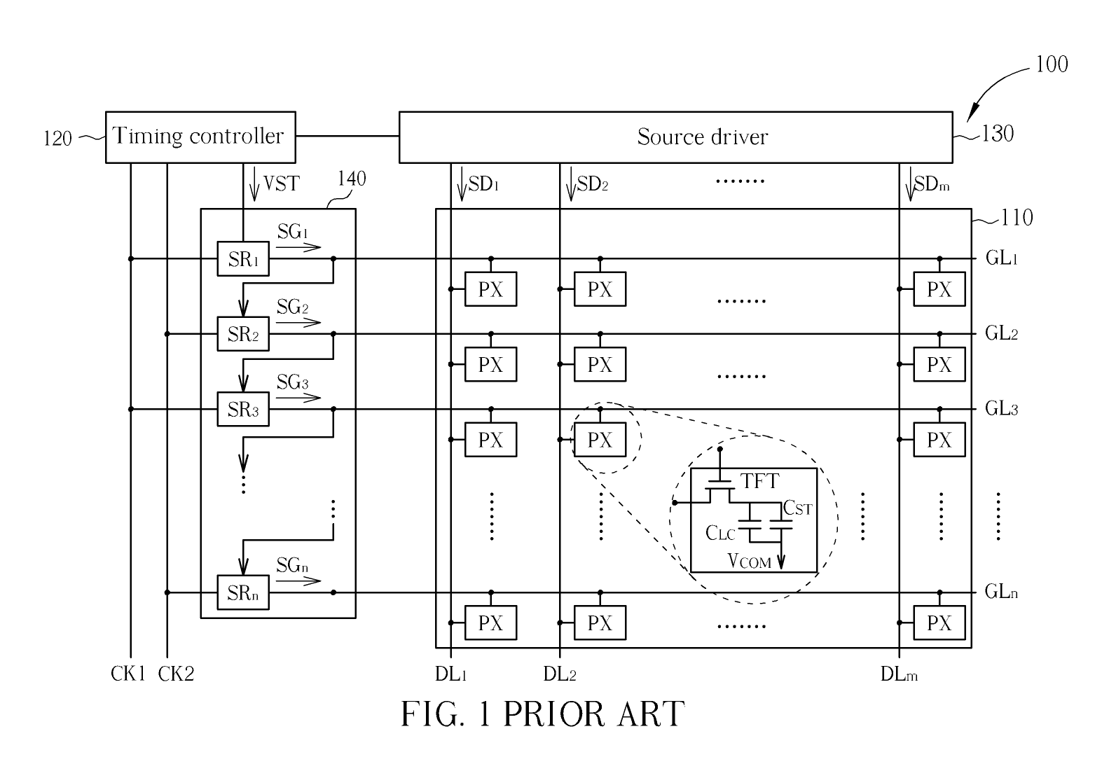

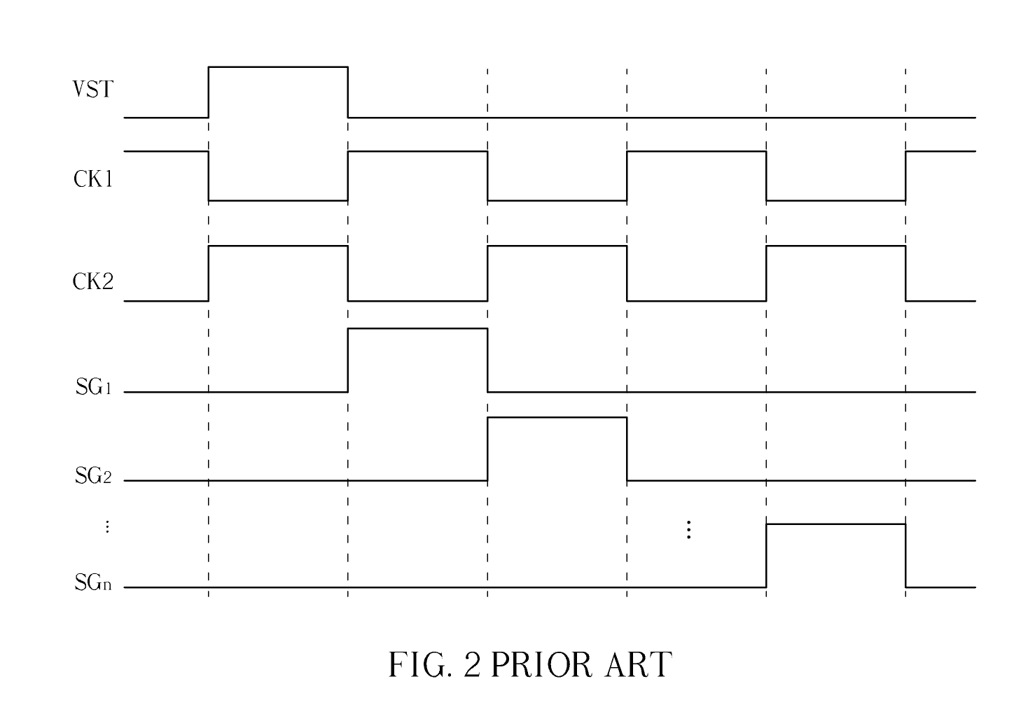

### DETAILED DESCRIPTION

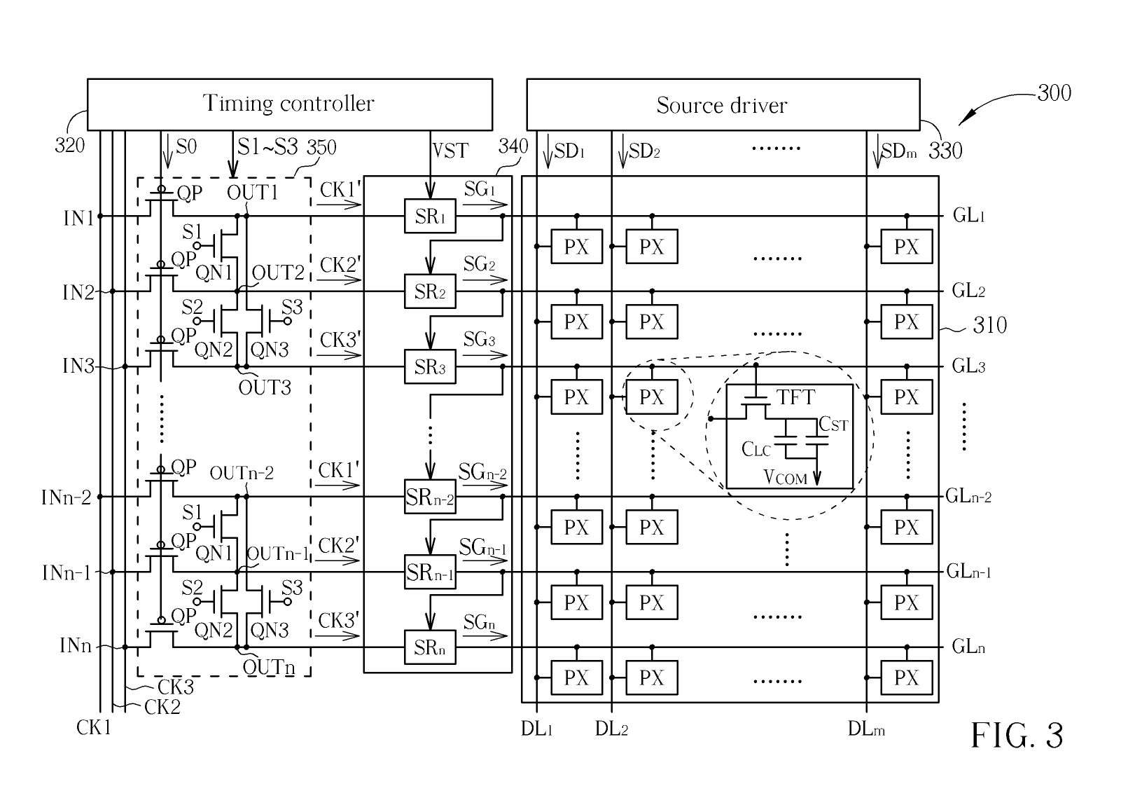

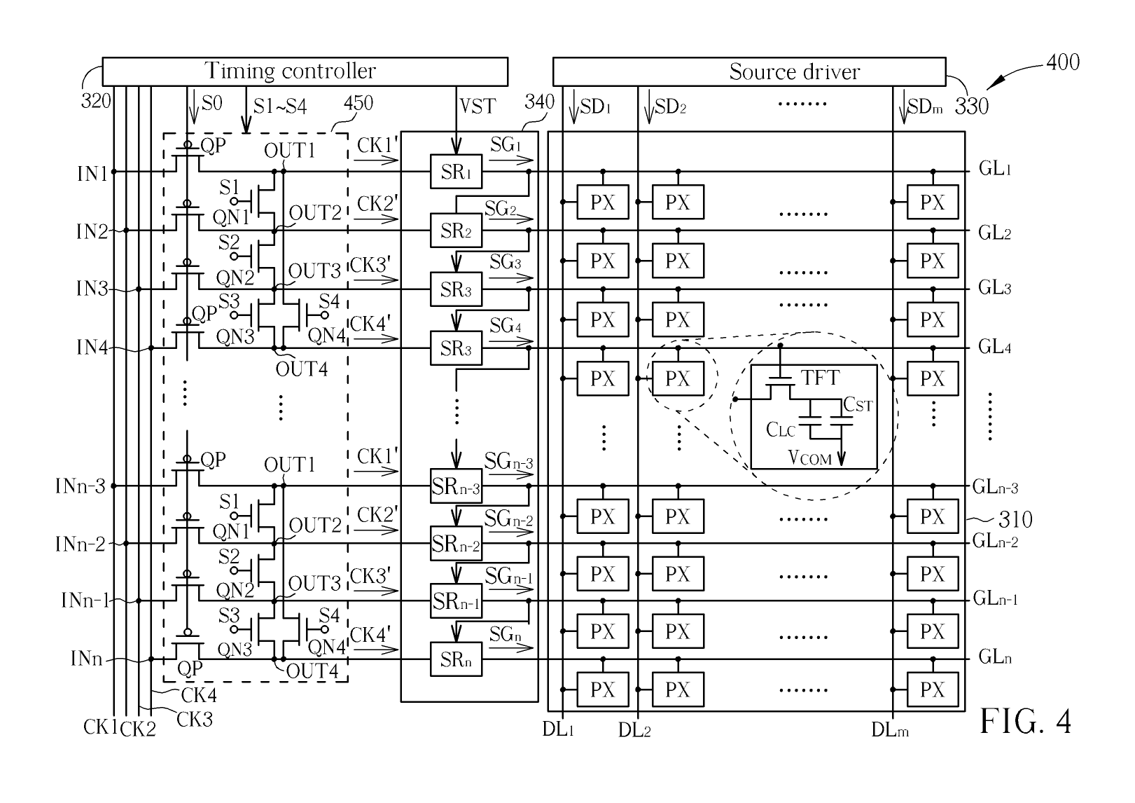

FIG. 3 and FIG. 4 are diagrams of an LCD device 300 and an LCD device 400 with GOA structure according to the present invention. The LCD devices 300 and 400 each include a display panel 310, a timing controller 320, a source driver 330, and a gate driver 340. The LCD device 300 includes a charge-sharing circuit 350 and the LCD device 400 includes a charge-sharing circuit 450. A plurality of data lines DL₁-DLₘ, a plurality of gate lines GL₁-GLₙ, and a pixel array are disposed on the display panel 310. The pixel array includes a plurality of pixel units PX each having a thin film transistor switch TFT, a liquid crystal capacitor C_{LC} and a storage capacitor C_{ST}, and coupled to a corresponding data line, a corresponding gate line, and a common voltage V_{COM}. The timing controller 320 is configured to generate signals required for operating the source driver 330, the gate driver 340 and the charge-sharing circuit 350 or 450, such as a start pulse signal VST, input clock signals CK1-CK4, and control signals S0-S4, etc. The source driver 330 is configured to generate data driving signals SD₁-SDₘ corresponding to display images, thereby charging the corresponding pixel units PX. The gate driver 340 is an n-phase shift register which includes a plurality of shift register units SR₁-SRₙ coupled in series. The gate driver 340 is configured to sequentially output the gate driving signals SG₁-SGₙ to the corresponding gate lines GL₁-GLₙ according to the input clock signals CK1-CKN and the start pulse signal VST, thereby turning on the thin film transistors TFT in the corresponding pixel units PX, wherein N and n are positive integers and 3≦N≦n). The charge-sharing circuit 350 or 450 is configured to allow charge-sharing to occur between each specific input clock signal and two other input clock signals among the input clock signals CK1-CKN respectively during the signal rising period and the signal falling period of each specific input clock signal, thereby providing corresponding output clock signals CK1′-CKN′.

FIG. 3 illustrates an embodiment when N=3 (assuming n is a multiple of 3). In FIG. 3, the gate driver 340 is a tri-phase shift register capable of sequentially outputting the gate driving signals SG₁-SGₙ for turning on the thin film transistor switches TFTs according to the output clock signals CK1′-CK3′ and the start pulse signal VST. The charge-sharing circuit 350 includes input ends IN1-INn, output ends OUT1-OUTn (which may also represent the n input ends of the gate driver 340), a plurality of switches QP and QN1-QN3. Each of the switches QP is respectively coupled between one of the input ends IN1-INn and the corresponding one of the output ends OUT1-OUTn, and is configured to operate according to the control signal S0 received from the timing controller 320. The switches QN1-QN3 are respectively coupled between two corresponding output ends among the output ends OUT1-OUTn, and are configured to operate according to the control signals S1-S3 received from the timing controller 320. In this embodiment, the switches QP and the switches QN1-QN3 are implemented with different doping. For example, the switches QP may be P-type metal oxide semiconductor (PMOS) transistor switches, and the switches QN1-QN3 may be N-type metal oxide semiconductor (NMOS) transistor switches.

FIG. 4 illustrates an embodiment when N=4 (assuming n is a multiple of 4). In FIG. 4, the gate driver 340 is a quad-phase shift register capable of sequentially outputting the gate driving signals SG₁-SGₙ for turning on the thin film transistor switches TFTs according to the output clock signals CK1′-CK4′ and the start pulse signal VST. The charge-sharing circuit 450 includes input ends IN1-INn, output ends OUT1-OUTn (which may also represent the n input ends of the gate driver 340), a plurality of switches QP and QN1-QN4. Each of the switches QP is respectively coupled between one of the input ends IN1-INn and the corresponding one of the output ends OUT1-OUTn, and is configured to operate according to the control signal S0 received from the timing controller 320. The switches QN1-QN4 are respectively coupled between two corresponding output ends among the output ends OUT1-OUTn, and are configured to operate according to the control signals S1-S4 received from the timing controller 320. In this embodiment, the switches QP and the switches QN1-QN4 are implemented with different doping. For example, the switches QP may be PMOS transistor switches, and the switches QN1-QN4 maybe NMOS transistor switches.

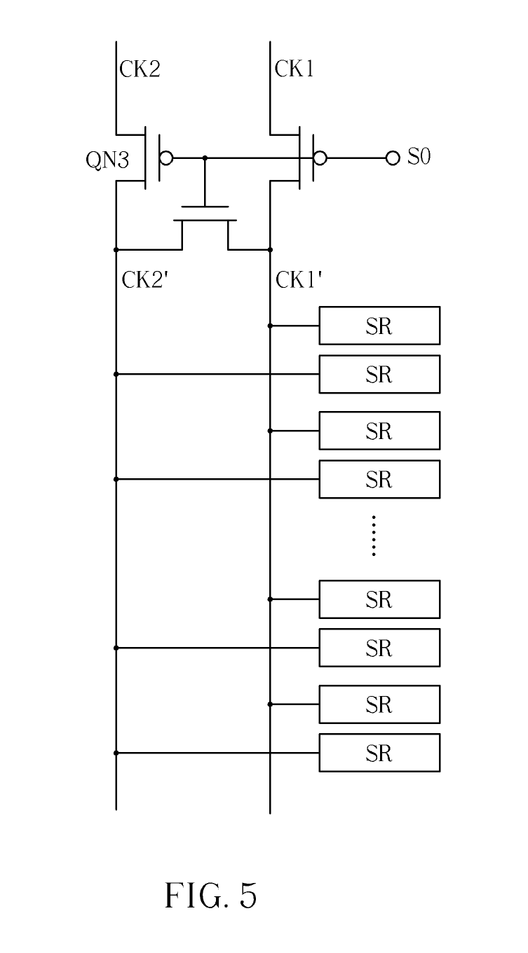

Furthermore, in the embodiments illustrated in FIG. 3 and FIG. 4, the charge-sharing circuits are disposed prior to the input of each shift register unit. However, it is not a limitation of the present invention. Please refer to FIG. 5. FIG. 5 is a diagram illustrating the charge-sharing circuit which is disposed prior to all control signals according to another embodiment of the present invention.

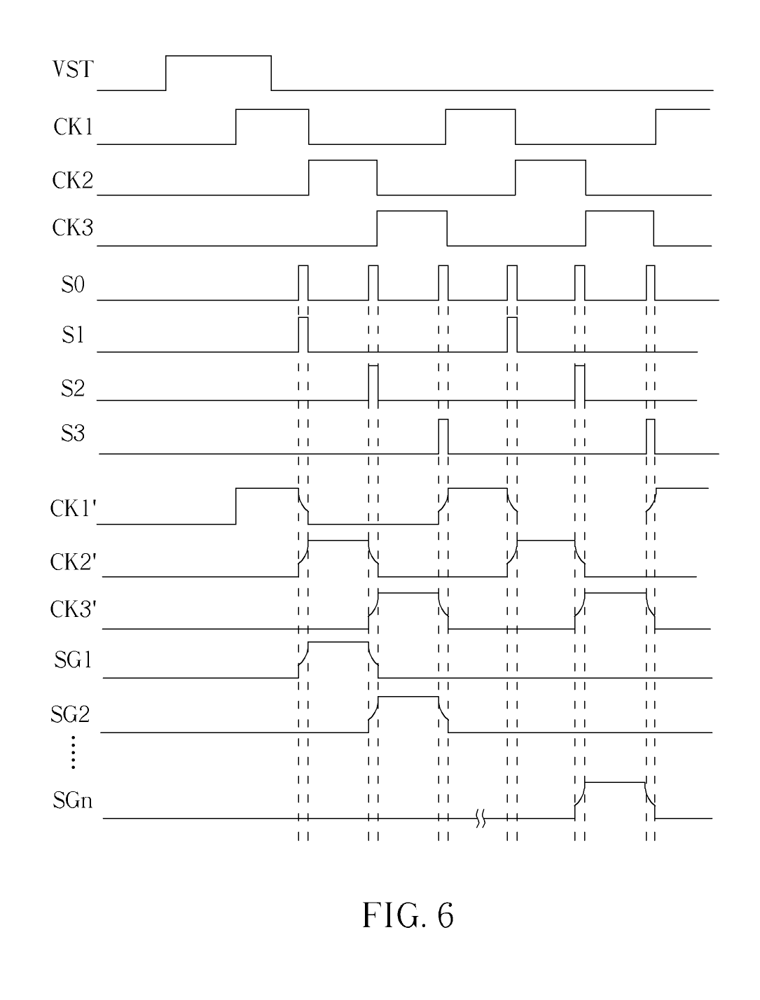

FIG. 6 is a diagram illustrating a driving method of the LCD device 300 according to the present invention. In FIG. 6, the waveforms of the input clock signals CK1-CK3, the output clock signals CK1′-CK3′, the control signals S0-S3, the start pulse signal VST, and the gate driving signals SG₁-SGₙ are depicted. According to the driving method illustrated in FIG. 6, the duty cycle of the clock signals CK1-CK3 is ⅓. When the control signals S0-S3 are at low level, the switches QP are turned on and the switches QN1-QN3 are turned off. The input clock signals CK1-CK3 generated by the timing controller 320 may thus be supplied as the output clock signals CK1′-CK3′. When two specific control signals among the control signals S0-S3 simultaneously switch to high level, charge-sharing may occur between two specific input clock signals among the input clock signals CK1-CK3. For instance, during the signal rising period of the input clock signal CK2, the control signals S0 and S1 simultaneously switch to high level. The switches QP are then turned off and the switch QN1 is turned on, thereby allowing charge-sharing to occur between the input clock signal CK2 and the input clock signal CK1 through the conducting switch QN1. During the signal falling period of the input clock signal CK2, the control signals S0 and S2 simultaneously switch to high level. The switches QP are then turned off and the switch QN2 is turned on, thereby allowing charge-sharing to occur between the input clock signal CK2 and the input clock signal CK3 through the conducting switch QN2. Similarly, during the signal rising period of the input clock signal CK1 when the control signals S0 and S3 simultaneously switch to high level, charge-sharing may occur between the input clock CK1 and the input clock signal CK3; during the signal falling period of the input clock signal CK1 when the control signals S0 and S1 simultaneously switch to high level, charge-sharing may occur between the input clock signal CK1 and the input clock signal CK2. During the signal rising period of the input clock signal CK3 when the control signals S0 and S2 simultaneously switch to high level, charge-sharing may occur between the input clock signal CK3 and the input clock signal CK2; during the signal falling period of the input clock signal CK3 when the control signals S0 and S3 simultaneously switch to high level and may occur between the input clock signal CK3 and the input clock signal CK1.

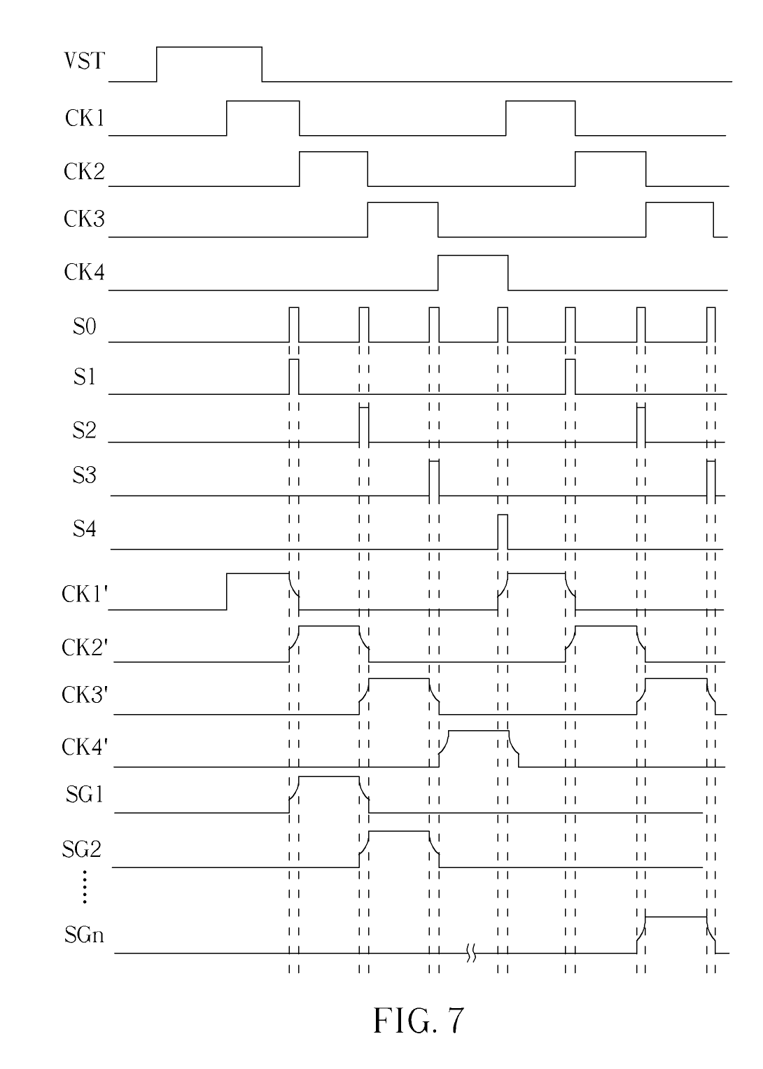

FIG. 7 is a diagram illustrating a driving method of the LCD device 400 according to the present invention. In FIG. 7, the waveforms of the input clock signals CK1-CK4, the output clock signals CK1′-CK4′, the control signals S0-S4, the start pulse signal VST, and the gate driving signals SG₁-SGₙ are depicted. According to the driving method illustrated in FIG. 7, the duty cycle of the clock signals CK1-CK4 is ¼. When the control signals S0-S4 are at low level, the switches QP are turned on and the switches QN1-QN4 are turned off. The input clock signals CK1-CK4 generated by the timing controller 320 may thus be supplied as the output clock signals CK1′-CK4′. When two specific control signals among the control signals S0-S4 simultaneously switch to high level, charge-sharing may occur between two specific input clock signals among the input clock signals CK1-CK4. As mentioned before, during the signal rising period of the input clock signal CK1 when the control signals S0 and S4 simultaneously switch to high level charge-sharing may occur between the input clock CK1 and the input clock signal CK4; during the signal falling period of the input clock signal CK1 when the control signals S0 and S1 simultaneously switch to high level, charge-sharing may occur between the input clock signal CK1 and the input clock signal CK2. During the signal rising period of the input clock signal CK2 when the control signals S0 and S1 simultaneously switch to high level, charge-sharing may occur between the input clock signal CK2 and the input clock signal CK1; during the signal falling period of the input clock signal CK2 when the control signals S0 and S2 simultaneously switch to high level, charge-sharing may occur between the input clock signal CK2 and the input clock signal CK3. During the signal rising period of the input clock signal CK3 when the control signals S0 and S2 simultaneously switch to high level, charge-sharing may occur between the input clock signal CK3 and the input clock signal CK2; during the signal falling period of the input clock signal CK3 when the control signals S0 and S3 simultaneously switch to high level, charge-sharing may occur between the input clock signal CK3 and the input clock signal CK4. During the signal rising period of the input clock signal CK4 when the control signals S0 and S3 simultaneously switch to high level, charge-sharing may occur between the input clock signal CK4 and the input clock signal CK3; during the signal falling period of the input clock signal CK4 when the control signals S0 and S4 simultaneously switch to high level, charge-sharing may occur between the input clock signal CK4 and the input clock signal CK1.

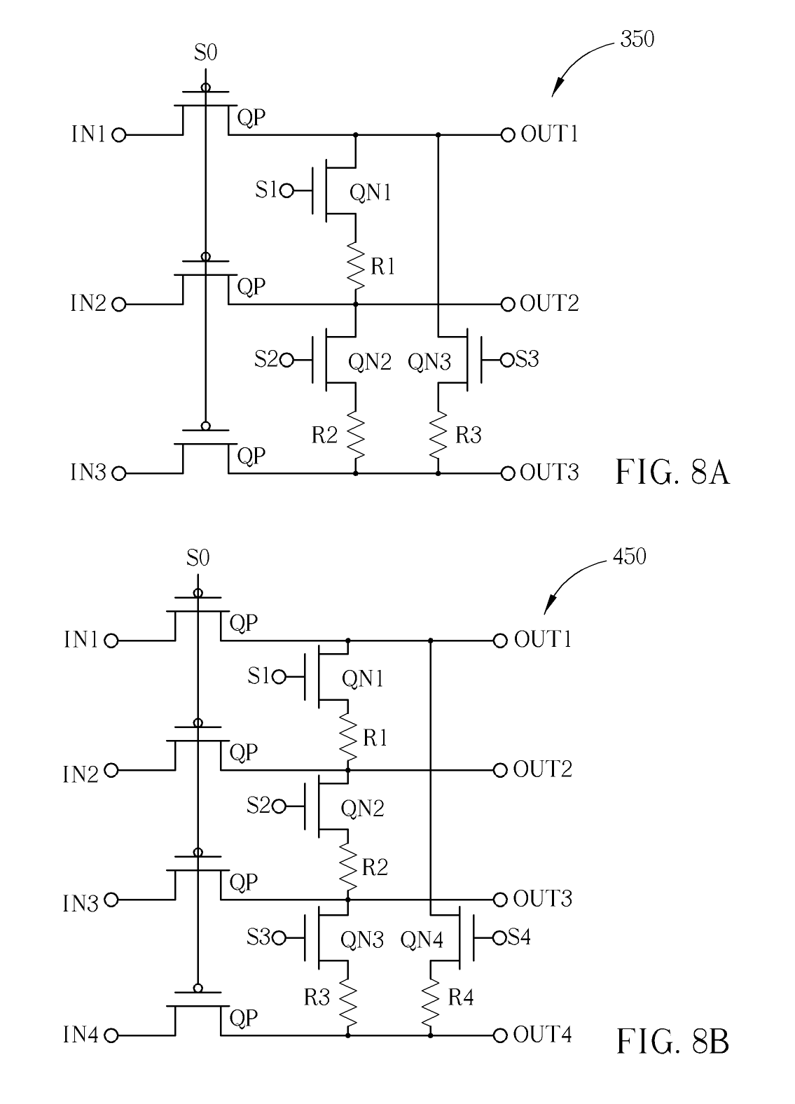

FIG. 8A and FIG. 8B are diagrams illustrating a charge-sharing circuit according to another embodiment of the present invention. In the embodiments illustrated FIG. 8A and FIG. 8B, the charge-sharing circuit 350 further includes resistors R1-R3, and the charge-sharing circuit 450 further includes resistors R1-R4. Each of the resistors is coupled in series to a corresponding switch and configured to limit current during charge-sharing.

In the LCD devices according to the present invention, charge-sharing is performed between each specific input clock signal among the input clock signals and two other different input clock signals during its signal rising period and its signal falling period, respectively. Therefore, the present invention can reduce power consumption and provide a flexible driving method for operating multi-phase shift registers.

The abovementioned embodiments are presented merely for describing features of the present invention, and in no way should be considered to be limitations of the scope of the present invention.

Those skilled in the art will readily observe that numerous modifications and alterations of the device and method may be made while retaining the teachings of the invention.

What is claimed is:

1. A method of driving a liquid crystal display (LCD) device, the method comprising:
providing a first to an N^{th} input clock signals each having a duty cycle of 1/N, wherein N is an integer larger than 2;
for a specific input clock signal among the first to the N^{th} input clock signals, allowing charge-sharing to occur between the specific input clock signal and two other input clock signals among the first to the N^{th} input clock signals during a signal rising period and a signal falling period of the specific input clock signal, respectively, thereby providing a first to an N^{th} output clock signals accordingly; and
generating a plurality of gate driving signals according to the first to the N^{th} output clock signals.

2. The method of claim 1, further comprising:
for an (n−1)^{th} input clock signal, an n^{th} input clock signal and an (n+1)^{th} input clock signal among the first to the N^{th} input clock signals, allowing charge-sharing to occur between the nth input clock signal and the (n−1)th input clock signal during a signal rising period of the nth input clock signal and allowing charge-sharing to occur between the nth input clock signal and the (n+1)th input clock signal during a signal falling period of the nth input clock signal, thereby providing a corresponding n^{th} output clock signal among the first to the N^{th} output clock signals, wherein n is an integer between 2 and (N−1).

3. The method of claim 2, further comprising:
allowing charge-sharing to occur between the first input clock signal and the N^{th} input clock signal during a signal rising period of the first input clock signal, thereby providing the corresponding first output clock signal; and
allowing charge-sharing to occur between the N^{th} input clock signal and the first input clock signal during a signal falling period of the N^{th} input clock signal, thereby providing the corresponding N^{th} output clock signal.

4. An LCD device, comprising:
a timing controller configured to provide a first to an N^{th} input clock signals each having a duty cycle of 1/N, wherein N is an integer larger than 2;
a charge-sharing circuit configured to allow charge-sharing to occur between a specific input clock signal and two other input clock signals among the first to the N^{th} input clock signals during a signal rising period and a signal falling period of the specific input clock signal, respectively, thereby providing a first to an N^{th} output clock signals accordingly; and
an N-phase shift register configured to generate a plurality of gate driving signals according to the corresponding first to the N^{th} output clock signals.

5. The LCD device of claim 4, wherein the charge-sharing circuit comprises:
a first to an N^{th} input ends for receiving the first to the N^{th} input clock signals, respectively;
a first to an N^{th} output ends for outputting the first to the N^{th} output clock signals, respectively;
a first to an N^{th} charge-sharing switches each coupled between a corresponding input end among the first to an N^{th} input ends and a corresponding output end among the first to an N^{th} output ends;
a first switch coupled between the first output end and the second output end; and
a second switch coupled between the second output end and the third output end.

6. The LCD device of claim 5, wherein the charge-sharing circuit further comprises:
a first resistor coupled between the first output end and the second output end, and coupled in series to the first switch; and
a second resistor coupled between the second output end and the third output end, and coupled in series to the second switch.

7. The LCD device of claim 5, wherein the timing controller is further configured to turn off the first to the N^{th} charge-sharing switches during a signal rising period and a signal falling period of each input clock signal, turn on the first switch during the signal rising period of the second input clock signal, and turn on the second switch during the signal falling period of the second input clock signal.

8. The LCD device of claim 5, wherein the charge-sharing circuit further comprises:
an N^{th} switch coupled between the first output end and the N^{th} output end.

9. The LCD device of claim 8, wherein the charge-sharing circuit further comprises:
an N^{th} resistor, coupled between the first output end and the N^{th} output end, and coupled in series to the N^{th} switch.

10. The LCD device of claim 8, wherein the timing controller is further configured to turn off the first to the N^{th} charge-sharing switches during the signal rising period and the signal falling period of each input clock signal, and turn on the N^{th} switch during the signal rising period of the first input clock signal and the signal falling period of the N^{th} input clock signal.

11. The LCD device of claim 4, further comprising a display panel which includes:
a plurality of data lines;
a plurality of gate lines, perpendicular to the plurality of data lines and configured to transmit the plurality of gate driving signals; and
a plurality of pixel units disposed at corresponding intersections of the plurality of data lines and the plurality of gate lines, wherein each of the plurality of pixel units is coupled to one corresponding data line among the plurality of data lines and one corresponding gate line among the plurality of gate lines, and configured to operate according to the gate driving signal received from the corresponding gate line.

12. The LCD device of claim 11, wherein each of the pixel units comprises:
a thin film transistor (TFT) switch, comprising:
a control end coupled to the corresponding gate line;
a first end coupled to the corresponding data line; and
a second end;
a liquid crystal capacitor coupled between the second end of the TFT switch and a common voltage; and
a storage capacitor, coupled between the second end of the TFT switch and the common voltage.

13. An LCD device, comprising:
a timing controller configured to provide a first to a third input clock signals and a first to a fourth control signals, wherein a duty cycle of each input clock signal does not exceed ⅓;
a shift register having a first to a third input ends; and
a charge-sharing circuit, comprising:
a first switch coupled between the first and second ends of the shift register and configured to selectively allow charge-sharing to occur between the first input clock signal and the second clock signal according to the first control signal;
a second switch coupled between the second and third ends of the shift register and configured to selectively allow charge-sharing to occur between the second input clock signal and the third clock signal according to the second control signal;
a first charge-sharing switch coupled between the timing controller and the shift register and configured to selectively transmit the first input clock signal from the timing controller to the first input end according to the fourth control signal;
a second charge-sharing switch coupled between the timing controller and the shift register and configured to selectively transmit the second input clock signal from the timing controller to the second input end according to the fourth control signal; and
a third charge-sharing switch coupled between the timing controller and the shift register and configured to selectively transmit the third input clock signal from the timing controller to the third input end according to the fourth control signal.

14. The LCD device of claim 13, further comprising:
a third switch coupled between the first and third input ends of the shift register and configured to selectively allow charge-sharing to occur between the first input clock signal and the third clock signal according to the third control signal.
